(19) United States
(12) Patent Application Publication
(10) Pub. No.: US 2002/0129960 A1
(43) Pub. Date: Sep. 19, 2002

(54) Sheathed conductor configuration for corrosive environmental conditions, and process for producing a sheathed conductor configuration

(76) Inventor: Wolfgang Maus, Bergisch Gladbach (DE)

Correspondence Address: LERNER AND GREENBERG, P.A., Post Office Box 2480, Hollywood, FL, 33022-2480, US

(21) Appl. No.: 10/097,508

(22) Filed: Mar. 14, 2002

Related U.S. Application Data
(63) Continuation of application No. PCT/EP00/08595, filed on Sep. 1, 2000.

(30) Foreign Application Priority Data
Sep. 14, 1999 (DE) 199 53 142.0

(51) Int. Cl. H01B 1/00; H02G 1/00; B21D 51/16

(52) U.S. Cl. 174/68.1; 29/890

(57) ABSTRACT

A sheathed conductor configuration for corrosive environmental conditions is disclosed. The sheathed conductor configuration has at least one internal electrical conductor that is electrically insulated from a metallic outer sheath by an electrically insulating material. The outer sheath is formed of steel that has subsequently been enriched with aluminum by diffusion.

### CROSS-REFERENCE TO RELATED APPLICATION

This application is a continuation of copending International Application No. PCT/EP00/08595, filed Sep. 1, 2000, which designated the United States.

### BACKGROUND OF THE INVENTION

### Field of the Invention

The present invention is based on a sheathed conductor configuration having at least one internal electrical conductor that can be used in corrosive environmental conditions, and on a process for producing a sheathed conductor configuration that is able to withstand corrosive environmental conditions.

Sheathed conductor configurations of this type are known in a wide variety of forms and, for example, as temperature sensors that can be used to measure the temperature on or in measurement objects which are able to withstand high temperatures. The temperature sensors contain a tubular metal sheath in which an electrical conductor is disposed in such a way that it is electrically insulated from the sheath. The conductor is in this case configured as a resistance wire, the resistance value for the wire being used to measure the temperature. To electrically insulate the conductor from the sheathing tube, it is usual to employ an electrically insulating bulk material which, after the sheathing tube has been pinched to form the flat temperature sensor, forms an insulating embedding compound for the resistance wire.

To ensure that temperature sensors of this type are protected from damage caused by corrosion, for example by high temperatures in the measurement environment, it is known for the sheath and/or the resistance wire to be made from corrosion-resistant metals and metal alloys. Thus, the internal conductor is usually produced from precious metal, such as for example platinum, while iron-chromium-aluminum alloys are used to produce the sheath. The iron-chromium-aluminum alloys generally have an aluminum content of up to 5% (percent by weight).

A drawback of such configurations is that the temperature sensors can only be machined and formed with difficulty, since the aluminum content in the alloys makes the sheathing conductor material brittle. There is a risk of the sheath being damaged by forming—for example the bending required for installation in a curved measurement object—and becoming cracked if there is a high aluminum content, which is in itself desirable.

### SUMMARY OF THE INVENTION

It is accordingly an object of the invention to provide a sheathed conductor configuration for corrosive environmental conditions, and a process for producing a sheathed conductor configuration that overcome the disadvantages of the prior art devices and methods of this general type, which is able to withstand corrosive conditions and which, in order to be fitted in measurement environments, can easily be adapted to the form of the measurement environment. A further object of the present invention is to provide a process for producing a sheathed conductor configuration that simplifies the production of sheathed conductor configurations that are able to withstand high temperatures.

With the foregoing and other objects in view there is provided, in accordance with the invention, a sheathed conductor configuration. The sheathed conductor configuration contains a metallic outer sheath formed from steel which has subsequently been enriched with aluminum by diffusion. At least one internal electrical conductor is disposed in the metallic outer sheath. An electrically insulating material is disposed in the metallic outer sheath and electrically insulating the internal electrical conductor from the metallic outer sheath.

The invention has the advantage that since the outer sheath of the sheathed conductor configuration consists of steel which is subsequently enriched with aluminum by diffusion, machining and/or forming of the sheathed conductor configuration in order to produce its final form (installation form, use form and the like) is readily possible. The sheathed conductor configuration can be processed using conventional metal-forming processes, such as cold-forming, hammering or pressing, and is nevertheless, following its manufacture, also able to withstand corrosive conditions due to the steel having subsequently been enriched with aluminum. The conflict existing hitherto between good formability, that is to say machinability, of the sheathed conductor configuration and good corrosion resistance, which can only be achieved with brittle metal alloys, is resolved by the sheathed conductor configuration according to the invention. The sheathed conductor configuration according to the invention is not only easy to produce but can also be brought into a desired form in a simple manner.

According to an advantageous configuration of the invention, the outer sheath contains chromium, in particular 22 to 25% (% by weight) chromium, and more than 6% (% by weight) aluminum.

It has been found that with this composition of the steel alloy the outer sheath is formed optimally in terms of its resistance to corrosion at high ambient temperatures and to its material-dependent service life.

According to another advantageous configuration of the invention, the internal electrical conductor is at least one resistance wire. This resistance wire may consist of a precious metal or another metal alloy, since it is completely surrounded by the corrosion-resistant outer sheath and in this way is protected by the latter. The electrically insulating material prevents electrical contact from being formed between the metallic resistance wire and the outer sheath.

According to another advantageous configuration of the invention, the sheathed conductor configuration is a temperature sensor that is known per se for installation in a catalytic converter of an exhaust system of an internal combustion engine. The temperature sensor is easy to change into the form in which it is to be attached to the catalytic converter as a function of its installation position. Nevertheless, the temperature sensor according to the invention exhibits high resistance to corrosive effects from the hot exhaust gases flowing past it. The temperature sensor according to the invention for catalytic converters is consequently distinguished by good processability combined with a high resistance to corrosion.

With the foregoing and other objects in view there is further provided, in accordance with the invention, a process for producing a sheathed device able to withstand corrosive environmental conditions. The process includes:

providing a metallic outer sheath containing chromium steel and a low aluminum content;

disposing at least one internal conductor and an insulating material inside the metallic outer sheath such that the internal conductor is electrically insulated from the metallic outer sheath;

processing the metallic outer sheath and the internal conductor to form an elongated sheathed conductor configuration;

coating the metallic outer sheath with aluminum on at least one of an outer side and an inner side; and

diffusing the aluminum from a surface of the metallic outer sheath substantially uniformly into the metallic outer sheath after the elongated sheathed conductor configuration has been formed into a final shape.

In accordance with an added feature of the invention, there is the step of providing the aluminum content of the metallic outer sheath to be less than 3% (percent by weight).

In accordance with another feature of the invention, there is the step of providing the aluminum content of the metallic outer sheath to be less than 1 (percent by weight).

In accordance with an additional feature of the invention, there is the step of forming the coating step by a hot-dip aluminizing process.

The process according to the invention for producing a sheathed conductor configuration which is able to withstand corrosive environmental conditions has the advantage that the inherently known processing of the sheathed conductor configuration, in particular the pinching to form an elongate sheathed conductor configuration and the forming to produce bent sheathed conductor configurations, can be carried out in a simple way, since the outer sheath consists of chromium steel with a low aluminum content. Processing of the sheathed conductor configuration is therefore simplified, since there is no need to take into account any brittleness of the material of the outer sheath. The outer sheath is coated with aluminum on its outer side and/or its inner side, the aluminum from the surface of the outer sheath being diffused into the outer sheath by diffusion annealing only after the final form of the sheathed conductor configuration has been produced. As a result, the sheathed conductor configuration is only made resistant to corrosive effects after the final form of the sheathed conductor configuration has been produced. According to an embodiment of the invention which is advantageous in this respect, the aluminum content of the outer sheath after the final form of the sheathed conductor configuration has been produced is more than 6% (% by weight). It has been found that sufficient resistance to corrosion on the part of sheathed conductor configurations of this type is not achieved if the aluminum forms less than 6% of the sheathed conductor material.

According to another advantageous configuration of the invention, the aluminum content of the outer sheath after the final form of the sheathed conductor configuration has been produced is more than 6% (% by weight), and the chromium content of the outer sheath is 22 to 25% (% by weight). A chromium steel/aluminum alloy of this type has proven to be particularly suitable for highly corrosive environmental conditions.

According to another advantageous configuration of the invention, the sheathed conductor configuration is used as a temperature sensor in high ambient temperatures, and the final form of the temperature sensor is adapted to the use environment and/or installation configuration. Particularly temperature sensors that are used at high ambient temperatures, such as, for example, temperatures of 1000° K. to 1500° K., must, on the one hand, be easily processable in order to produce their final form and nevertheless must be able to withstand corrosive effects in their use form. An essential advantage of the process according to the invention for producing temperature sensors resides in the fact that even those temperature sensors whose aluminum content is more than 6% (% by weight) can be produced in any desired form.

According to another embodiment of the process according to the invention that is advantageous in this respect, the sheathed conductor configuration is fitted as a temperature sensor into a catalytic converter of an internal combustion engine. The final form of the temperature sensor in the process is adapted to installation in the catalytic converter. The advantages of the process according to the invention become clear in particular for temperature sensors for catalytic converters, which are increasingly being produced in large series. One requirement of these temperature sensors is that they can be produced as inexpensively as possible, while a second requirement is that they be easily processable. It must be possible to adapt the final form of these temperature sensors to a wide variety of different catalytic converters, while on the other hand the sensors have to have a high longs term endurance, in particular with respect to the corrosive effects of the exhaust gases flowing past them. With the process according to the invention, it is possible to produce temperature sensors of this type at low cost and in a simple manner.

In accordance with a concomitant feature of the invention, there is the step of producing the final shape of the elongated sheathed conductor configuration by at least one of a machining process and a forming process such as a cold forming process.

Other features which are considered as characteristic for the invention are set forth in the appended claims.

Although the invention is illustrated and described herein as embodied in a sheathed conductor configuration for corrosive environmental conditions, and a process for producing a sheathed conductor configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective and partially cut-away view of a sheathed conductor configuration with a tubular outer sheath according to the invention;

FIG. 2 is a partially cut-away plan view of the sheathed conductor configuration with an outer sheath that has a flat configuration;

FIG. 3 is a partially cut-away, side elevational view of the sheathed conductor configuration shown in FIG. 2; and

FIG. 4 is a partially cut-away, side elevational view of the sheathed conductor configuration shown in FIGS. 2 and 3 in bent form.

### DESCRIPTION OF THE PREFERRED EMBODIMENTS

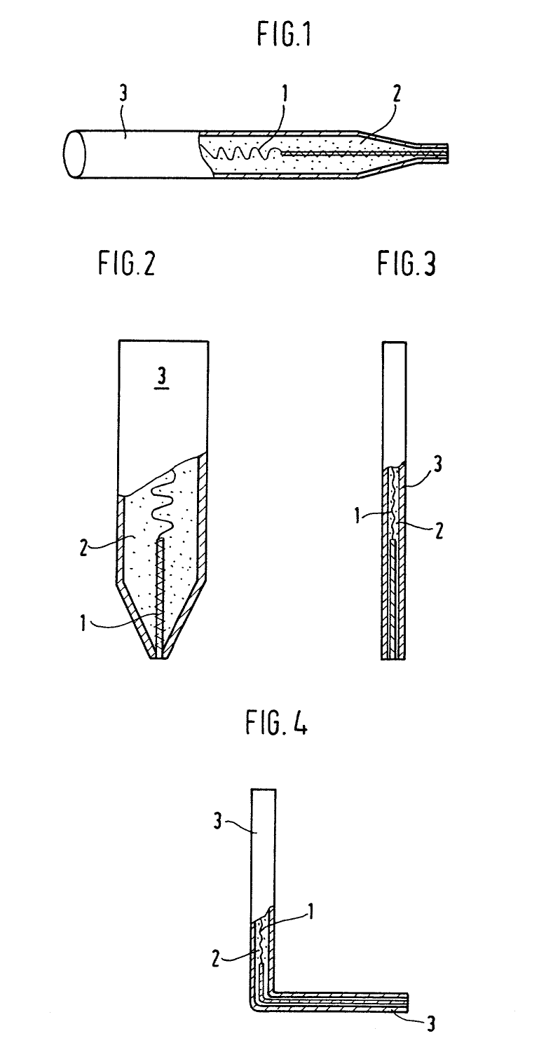

In all the figures of the drawing, sub-features and integral parts that correspond to one another bear the same reference symbol in each case. Referring now to the figures of the drawing in detail and first, particularly, to FIG. 1 thereof, there is shown a sheathed conductor configuration. The sheathed conductor configuration has as an internal electrical conductor being in a form of a resistance wire 1 that has a winding form and is completely surrounded by an electrically insulating material 2. The resistance wire 1 can consist, for example, of a metal alloy or a precious metal. The electrically insulating material 2 in the exemplary embodiment is an embedding compound in the form of bulk material, which is filled into a tubular outer sheath 3 of the sheathed conductor configuration. The outer sheath 3 of the sheathed conductor configuration consists of steel that is subsequently enriched with aluminum by diffusion. The aluminum enrichment may, for example, be produced by diffusion annealing. The fact that the outer sheath 3 is only subsequently enriched with aluminum results in that the sheathed conductor configuration is distinguished by the fact that it is easily processable in order to produce its final form. Processing of the sheathed conductor configuration may, for example, be carried out by deforming the outer sheath 3, during which process the resistance wire 1 together with the insulating material 2 surrounding it can also be deformed.

FIG. 2 shows the sheathed conductor configuration in which the outer sheath 3 is of a flat configuration. This sheathed conductor configuration was deformed into a flat sheathed conductor configuration in accordance with the description given above, by pinching together the tubular outer sheath 3. Even after pinching, the resistance wire 1 is insulated from the outer sheath 3 by the electrically insulating material 2, as can be seen clearly from FIG. 3.

FIG. 4 shows a partially cut-away side view of the sheathed conductor configuration from FIGS. 2 and 3, in which the sheathed conductor configuration is of bent form. In this sheathed conductor configuration, the outer sheath 3, which is has a flat configuration, is made into the final form of the sheathed conductor configuration by bending. In this case too, the resistance wire 1 is insulated from the outer sheath 3 by the electrically insulating material 2. Unlike the sheathed conductor configuration from FIGS. 2 and 3, the outer sheath 3 in this case consists of steel that has already been enriched with aluminum. Since the sheathed conductor configuration is in its final form and therefore there is no need for any further machining or deforming, the outer sheath 3 can be enriched with aluminum. The brittleness of steel-aluminum alloys is no longer of any importance.

I claim:

1. A sheathed conductor configuration, comprising:
a metallic outer sheath formed from steel which has subsequently been enriched with aluminum by diffusion;
at least one internal electrical conductor disposed in said metallic outer sheath; and
an electrically insulating material disposed in said metallic outer sheath and electrically insulating said internal electrical conductor from said metallic outer sheath.

2. The sheathed conductor configuration according to claim 1, wherein said metallic outer sheath contains chromium and more than 6% (percent by weight) of said aluminum.

3. The sheathed conductor configuration according to claim 1, wherein said internal electrical conductor is at least one resistance wire.

4. The sheathed conductor configuration according to claim 1, wherein said metallic outer sheath, said internal electrical conductor, and said electrically insulating material form a temperature sensor for installation in a catalytic converter of an exhaust system of an internal combustion engine.

5. The sheathed conductor configuration according to claim 1, wherein said metallic outer sheath, said internal electrical conductor, and said electrically insulating material form a temperature sensor for use in corrosive environmental conditions.

6. The sheathed conductor configuration according to claim 2, wherein said metallic outer sheath contains 22 to 25% (percent by weight) of said chromium.

7. A process for producing a sheathed device able to withstand corrosive environmental conditions, which comprises the steps of:
providing a metallic outer sheath containing chromium steel and a low aluminum content;
disposing at least one internal conductor and an insulating material inside the metallic outer sheath such that the internal conductor is electrically insulated from the metallic outer sheath;
processing the metallic outer sheath and the internal conductor to form an elongated sheathed conductor configuration;
coating the metallic outer sheath with aluminum on at least one of an outer side and an inner side; and
diffusing the aluminum from a surface of the metallic outer sheath substantially uniformly into the metallic outer sheath after the elongated sheathed conductor configuration has been formed into a final shape.

8. The process according to claim 7, which comprises providing the aluminum content of the metallic outer sheath to be less than 3% (percent by weight).

9. The process according to claim 7, which comprises providing the aluminum content of the metallic outer sheath to be less than 1 (percent by weight).

10. The process according to claim 7, which comprises performing the coating step by a hot-dip aluminizing process.

11. The process according to claim 7, which comprises performing the coating step so that the aluminum content of the metallic outer sheath is more than 6% (percent by weight).

12. The process according to claim 7, which comprises performing the coating step such that the aluminum content of the metallic outer sheath is more than 6% (percent by weight) and a chromium content of the metallic outer sheath is 22 to 25% (percent by weight).

13. The process according to claim 7, which comprises using the sheathed conductor configuration as a temperature sensor in high ambient temperatures and the final shape of the temperature sensor is adapted to at least one of a use environment and an installation configuration.

14. The process according to claim 13, which comprises forming the temperature sensor for use in a temperature range of 10000° K. to 15000° K.

15. The process according to claim 13, which comprises fitting the temperature sensor into a catalytic converter of an internal combustion engine, and the final shape of the temperature sensor is adapted for installation in the catalytic converter.

16. The process according to claim 15, which comprises producing the final shape of the elongated sheathed conductor configuration by at least one of a machining process and a forming process.

17. The process according to claim 16, which comprises using a cold forming process as the forming process.
